(19) United States
(12) Patent Application Publication
(10) Pub. No.: US 2009/0307972 A1
(43) Pub. Date: Dec. 17, 2009

(54) Substrate for plants in an aquarium, terrarium and the like

(76) Inventor: Rene OTTEVANGER, Gravenzande (NL)

Correspondence Address: YOUNG & THOMPSON, 209 Madison Street, Suite 500, Alexandria, VA, 22314, US

(21) Appl. No.: 12/136,850

(22) Filed: Jun. 11, 2008

(51) Int. Cl. A01G 9/00; A01G 9/02

(52) U.S. Cl. 47/59 S; 47/66.6

(57) ABSTRACT

A substrate for plants comprises at least two connected layers, one layer of which comprises a porous polyester material, and the other layer of which comprises another porous material. The water-retaining properties of this layer are better than those of the porous polyester material. The layer of porous polyester material may comprise polyester fibres, preferably polyester fibres which are entangled and/or arranged arbitrarily.

The invention relates to a substrate in which plants can take root, in particular plants intended for an aquarium, terrarium or a paludarium and the like. With all these applications, it is important that the substrate has sufficient open spaces and/or is sufficiently porous in order to accommodate the roots of the plant in question. In addition, it is important that the substrate meets other requirements in connection with the respective use.

If the substrate is used in an aquarium, for example, the specific weight of the substrate which is satured with water has to be greater than the specific weight of water, since the substrate has to be able to remain on the bottom of the aquarium without requiring additional measures to prevent it from floating up. With other uses, other additional requirements apply. Thus, when the substrate is used in a terrarium, it will have to satisfy the requirement that it can retain water.

Until now, it was known to use mineral wool as a substrate for plants, in particular rock wool. With this use, the plants take root in the rock wool, while water is supplied in a controlled manner, for example via drippers. When the substrate is used in a paludarium, also referred to as an aquaterrarium or river tank, it may have to satisfy both requirements.

In practice, the use of the substrate in the form of mineral wool with these applications was found to have significant drawbacks. The use of mineral wool as substrate in an aquarium may result in problems with regard to floating. In particular, rock wool in which plants have taken root is at risk of floating, so that additional measures have to be taken to anchor the substrate with plants to the bottom. This is undesirable, as it is often not possible to make provision for such anchoring arrangements. Furthermore, it has been found that with this application, the substrate becomes saturated with water to such a degree that the roots of the plants are barely able to take up any oxygen.

It is therefore an object of the invention to provide a substrate for the abovementioned applications, that is to say a substrate which is suitable for use in an aquarium, terrarium or paludarium and which ensures that the roots of plants can both take root therein and also take up oxygen. This object is achieved by means of a substrate for plants, comprising at least two connected layers, one layer of which comprises a porous polyester material, and the other layer of which comprises another porous material which has water-retaining properties which are better than those of the porous polyester material.

The substrate according to the invention uses a top layer made of porous polyester material, in which the roots of the plants can readily take root. The polyester material has the advantage that it does not clog up as a result of, for example, the growth of bacteria, when used in an aquarium, so that the roots of the plants are still able to take up water and oxygen. When used in a terrarium, for example, the advantage is that the other layer can retain water well, so that drying out can substantially be prevented.

The combination of a layer made from polyester moistened with water has to be able to remain on the bottom of an aquarium. This can be achieved by using mineral wool, such as rock wool, for the other layer. Mineral wool saturated with water is relatively heavy, so that a stable position is ensured.

The layer of porous polyester material preferably comprises polyester fibres. Such a polyester material is known per se as a substrate from Netherlands patent 1024446. As has already been mentioned, however, such a polyester material itself is not suitable for use in, for example, an aquarium, as a substrate which is produced in this way would float.

The substrate according to the invention preferably comprises polyester fibres which are entangled with one another and/or arranged arbitrarily. In particular, the polyester fibres may be connected to one another by means of a synthetic bonding agent, such as an adhesive. Alternatively, the connection between the fibres can also be produced by means of, for example, a thermal bond. However, it is not absolutely necessary to use polyester in the form of entangled fibres in the substrate according to the invention. Thus, it is also possible to use polyester in the form of a foam. Polyester in the form of a foam is known per se from French patent application 2,599,934. However, this publication does not state how such a material could be made suitable for use in an aquarium either.

As has already been mentioned above, the substrate according to the invention also comprises a layer of mineral wool. In particular, this may be rock wool.

With a view to making the plants take root in the layer of porous polyester material, said layer may comprise blind holes which open onto the side turned away from the layer of rock wool. In particular, said holes may extend as far as the layer of mineral wool. In that case, the roots also have access to the layer of mineral wool saturated with water, which may be advantageous, in particular in the case of a terrarium, paludarium and the like, in order to prevent drying out. The holes may at least partially be filled with plugs made from a material which is suitable for the development of plant roots.

Furthermore, the other layer may comprise blind holes which open onto the side turned away from the layer of polyester material.

The substrate according to the invention is readily able to meet the imposed requirements provided that the various layers remain connected. In this connection, consideration may be given to bonding the layers together, but such a connection is not suitable for all uses. When the substrate is used in an aquarium, for example, the use of adhesive is avoided as much as possible, since the various ingredients thereof may dissolve in the water and may adversely affect the environment. This may then have an adverse effect on the plants and fish which are present in the aquarium. According to a preferred embodiment, joining means therefore extend around the layers.

In particular, said joining means may comprise a net, so that the plants are still readily able to access the substrate via the mesh. The net may, for example, be sleeve-shaped, but other embodiments which, for example, surround the substrate in its entirety, are also possible. In addition, consideration may also be given to other joining means, such as threads, wires, elastic bands and the like.

The invention furthermore relates to a growing medium, comprising a substrate as described above, in which the substrate may, for example, be block-shaped or mat-shaped. The thickness of the substrate is chosen as a function of the plant, such as the size thereof the requirements of the plant in connection with the development of the root system and the like.

Furthermore, the invention relates to, in combination, an aquarium, terrarium or paludarium and the like, as well as a substrate as described above, in which the layer of mineral wool of the substrate may be in contact with a base surface in the interior of the aquarium and the like.

The invention will be explained in more detail below with reference to some exemplary embodiments illustrated in the drawings, in which:

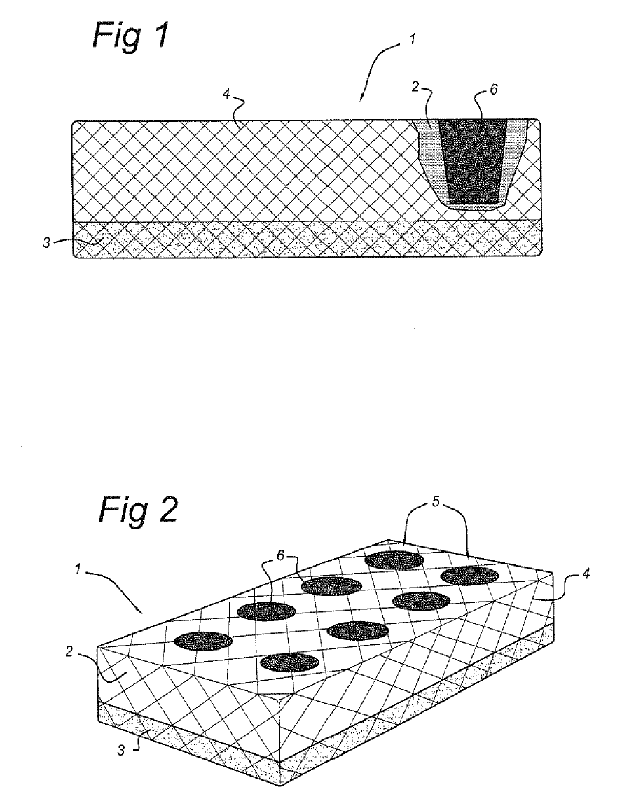

FIG. 1 shows a substrate according to the invention in side view;

FIG. 2 shows the substrate in perspective;

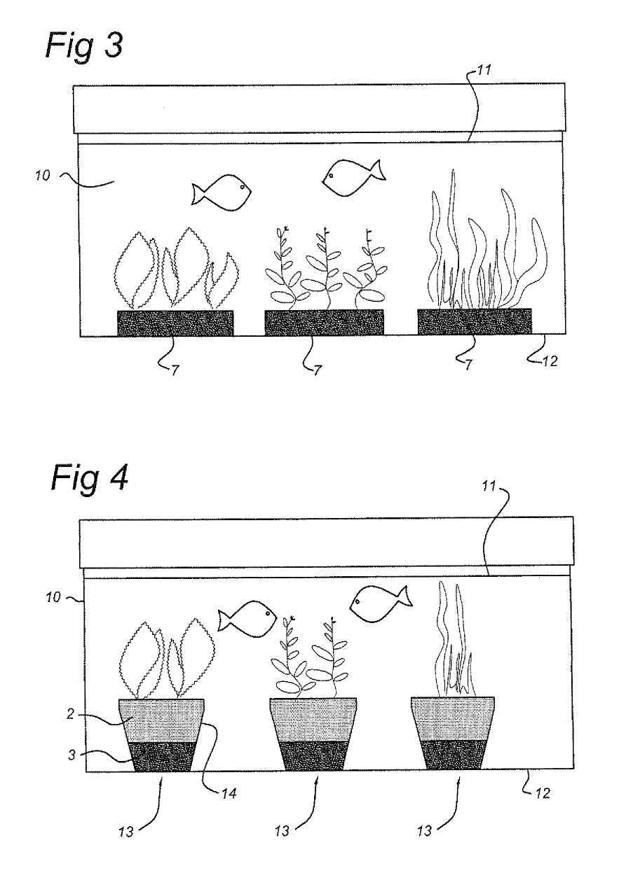

FIG. 3 shows a cross section through an aquarium with a growing medium according to the invention;

FIG. 4 shows a second variant of an aquarium.

The substrate 1 according to the invention illustrated in FIGS. 1 and 2 comprises a layer of polyester 2 and a layer of mineral wool, such as rock wool 3, underneath. Said layers 2, 3 are held together by a plastic net 4, which is of sleeve-shaped design and extends around the layers 2, 3 in such a manner that these are continuously pressed together. The layer of polyester 2 contains a number of openings 5, which, as can be seen in FIG. 1, extend up to the layer of mineral wool 3. These openings 5 contain plugs 6, likewise made of a porous material, such as polyester, in which cuttings may take root.

Such a substrate designed as a growing medium 7 may, for example, be supplied with plants rooted therein, in such a manner that these can immediately be placed into the aquarium 10 as illustrated in FIG. 3. In FIG. 3, various growing mediums 7 of this kind are illustrated, each containing different plants.

The water level in the aquarium 10 is indicated by reference numeral 11. As a result of the relatively heavy layer of mineral wool, the growing mediums 7 remain on the bottom 12 of the aquarium 10, without there being any risk of them floating.

In the exemplary embodiment of the aquarium in FIG. 4, alternative growing mediums 13 are used, comprising a pot 14 containing a correspondingly formed substrate 1. This pot-shaped substrate 15 also comprises a layer 3 of mineral wool, as well as a layer 2 of porous polyester material on top thereof.

1. Substrate (I) for plants, comprising at least two connected layers (2, 3), one layer (2) of which comprises a porous polyester material, and the other layer (3) of which comprises another porous material which has water-retaining properties which are better than those of the porous polyester material.

2. Substrate (1) according to claim 1, in which the layer of porous polyester material (2) comprises polyester fibres.

3. Substrate (1) according to claim 2, in which the polyester fibres are entangled with one another and/or arranged arbitrarily.

4. Substrate (1) according to claim 2, in which the polyester fibres are connected to one another by means of a synthetic bonding agent.

5. Substrate (I) according to claim 2, in which the polyester fibres are connected to one another, for example by a thermal bond.

6. Substrate (1) according to claim 1, in which the other layer (3) comprises a mineral wool.

7. Substrate (I) according to claim 6, in which the mineral wool (3) comprises a rock wool.

8. Substrate (1) according to claim 1, in which the layer of porous polyester material (2) comprises blind holes (5) which open onto the side turned away from the other layer (3).

9. Substrate (1) according to claim 8, in which the holes (5) extend as far as the other layer (3).

10. Substrate (1) according to claim 1, in which the other layer (3) comprises blind holes which open onto the side turned away from the layer of polyester material (1).

11. Substrate (1) according to one claim 1, in which joining means (4) extend around the layers (2, 3).

12. Substrate (1) according to claim 11, in which the joining means comprise a net (4).

13. Substrate (1) according to claim 12, in which the net (4) is sleeve-shaped.

14. Growing medium (7), comprising a substrate (1) according to claim 1, in which the substrate (I) has a shaped periphery, such as a block shape, cylinder shape or mat shape.

15. Growing medium (13) according to claim 14, in which the substrate (1) has the external shape of a pot.

16. In combination, an aquarium (10), terrarium or paludarium and the like, as well as a substrate (1) or growing medium (7, 13) according to claim 1.

17. Combination according to claim 16, in which the layer of mineral wool (3) of the substrate is turned towards the base surface (12) of the aquarium (10) and the like.

18. Combination according to claim 16, in which water is provided in the aquarium (10) and the like, and the substrate (1) is in the water.

19. Combination according to claim 18, in which water plants are rooted in the substrate (1).

20. Combination according to claim 17, in which the substrate is situated in a dry area.

21. Combination according to claim 16, in which the substrate is situated in a moist area.
